(19) United States
(12) Patent Application Publication
(10) Pub. No.: US 2025/0225640 A1
(43) Pub. Date: Jul. 10, 2025

(54) SEGMENTATION-BASED CARE AREA SETUP FOR INSPECTION OF A SPECIMEN USING EDGE DETECTION

(71) Applicant: KLA Corporation, Milpitas, CA (US)

(72) Inventors: Raja Barnwal, Durgapur (IN); Tushar Kamble, Mumbai (IN)

(21) Appl. No.: 18/907,563

(22) Filed: Oct. 6, 2024

Related U.S. Application Data
(60) Provisional application No. 63/555,905, filed on Feb. 21, 2024.

(30) Foreign Application Priority Data
Jan. 4, 2024 (IN) 202441000838

(51) Int. Cl. G06T 7/00; G06T 7/11; G06T 7/13; G06T 7/136

(52) U.S. Cl. CPC G06T 7/0006; G06T 7/11; G06T 7/13; G06T 7/136; G06T 2207/10061; G06T 2207/20104; G06T 2207/20221; G06T 2207/30148

(57) ABSTRACT

Methods and systems for setting up care areas (CAs) for inspection of a specimen are provided. One system includes a computer subsystem configured for acquiring an area of interest image for a specimen from images of the specimen generated by an imaging subsystem. The computer subsystem segments the area of interest image based on intensity of pixels in the image thereby separating the image into pixels corresponding to one or more specimen structures in the image having an intensity different than other pixels in the image. In addition, the computer subsystem detects edges of the specimen structure(s) in the image based on the pixels corresponding to the specimen structure(s) and determines characteristic(s) of one or more CAs in the images of the specimen based on the detected edges. The computer subsystem further stores information for the CA(s) for use in inspection of the specimen.

### BACKGROUND OF THE INVENTION

### 1. Field of the Invention

The present invention generally relates to methods and systems for setting up care areas for inspection of a specimen. Certain embodiments relate to using image intensity and edge detection to set up care areas.

### 2. Description of the Related Art

The following description and examples are not admitted to be prior art by virtue of their inclusion in this section.

Inspection processes are used at various steps during a semiconductor manufacturing process to detect defects on reticles and wafers to promote higher yield in the manufacturing process and thus higher profits. Inspection has always been an important part of fabricating semiconductor devices. However, as the dimensions of semiconductor devices decrease, inspection becomes even more important to the successful manufacture of acceptable semiconductor devices because smaller defects can cause the devices to fail.

“Care areas” as they are commonly referred to in the art are areas on a specimen that are of interest for inspection purposes. Sometimes, care areas (CAs) are used to differentiate between areas on the specimen that are inspected from areas on the specimen that are not inspected in an inspection process. In addition, CAs are sometimes used to differentiate between areas on the specimen that are to be inspected with one or more different parameters. For example, if a first area of a specimen is more critical than a second area on the specimen, the first area may be inspected with a higher sensitivity than the second area so that defects are detected in the first area with a higher sensitivity. Other parameters of an inspection process can be altered from CA to CA in a similar manner.

Different categories of inspection CAs are currently used. One category is legacy CAs, which are traditionally hand drawn. With nearly all users adopting design guided inspection, very few legacy CAs are currently used. Another category is design based CAs. These are CAs derived based on heuristics on chip design patterns printed on the specimen. The user tries to look at the chip design and derive methods/scripts that will help derive CAs. There are multiple techniques and tools available to define these design based CAs. As they are derived from ground truth (chip design), they can provide high precision, substantially tiny CAs and also allow inspection systems to store high volumes of CAs. These CAs are important not just from a defect detection standpoint, but they are often crucial to noise suppression.

Despite there being numerous ways to generate CAs, the inventors are not aware of any methods that use pixel intensity from die-based features to create CAs. Intensity-based segmentation may currently be used to flag pixels for tuning sensitivity (e.g., defect detection algorithm setup). However, this does not provide the flexibility offered by CAs. In other words, setting a defect detection threshold based on intensity of different segments of pixels may help to suppress nuisance and noise in the inspection results while trying to detect defects with the required sensitivity, but it does not provide as many options as CAs do such as intentionally inspecting certain areas or structures on the specimen with specified defect detection parameters.

Many of the CA setup methods and systems currently in use also have a number of disadvantages. For example, methods that setup CAs using design information for the specimen are computationally expensive and require access to intellectual property such as graphical data stream (GDS) files. However, the entity that owns and/or operates the inspection tool may not be the same as the entity that owns the design being fabricated on specimens inspected with the tool. As such, design information for the specimen may not be available at all in some inspection tool use cases. In addition, manually drawing CAs has obvious disadvantages. For example, CAs may be manually drawn to separate the target features, but this is obviously time consuming and manpower intensive as there could be 1000+ intricate features in a die. Therefore, in many cases, manual CA setup is so expensive and impractical that it is only resorted to when other automated or semi-automated options are unavailable.

Accordingly, it would be advantageous to develop systems and methods for setting up CAs for inspection of a specimen that do not have one or more of the disadvantages described above.

### SUMMARY OF THE INVENTION

The following description of various embodiments is not to be construed in any way as limiting the subject matter of the appended claims.

One embodiment relates to a system configured for setting up care areas (CAs) for inspection of a specimen. The system includes an imaging subsystem configured for generating images of a specimen and a computer subsystem configured for acquiring an area of interest image for the specimen from one or more of the images generated by the imaging subsystem. The computer subsystem is also configured for segmenting the area of interest image based on intensity of pixels in the area of interest image thereby separating the area of interest image into pixels corresponding to one or more specimen structures in the area of interest image having an intensity different than other pixels in the area of interest image. In addition, the computer subsystem is configured for detecting edges of the one or more specimen structures in the area of interest image based on the pixels corresponding to the one or more specimen structures and determining one or more characteristics of one or more CAs in the images of the specimen based on the detected edges. The computer subsystem is further configured for storing information for the one or more CAs for use in inspection of the specimen. The system may be further configured as described herein.

Another embodiment relates to a computer-implemented method for setting up CAs for inspection of a specimen. The method includes the acquiring, segmenting, detecting, determining, and storing steps described above. The steps of the method are performed by a computer subsystem coupled to the imaging subsystem described above. Each of the steps of the method may be performed as described further herein. The method may include any other step(s) of any other method(s) described herein. The method may be performed by any of the systems described herein.

Another embodiment relates to a non-transitory computer-readable medium storing program instructions executable on a computer system for performing a computer-implemented method for setting up CAs for inspection of a specimen. The computer-implemented method includes the steps of the method described above. The computer-readable medium may be further configured as described herein. The steps of the computer-implemented method may be performed as described further herein. In addition, the computer-implemented method for which the program instructions are executable may include any other step(s) of any other method(s) described herein.

### BRIEF DESCRIPTION OF THE DRAWINGS

Further advantages of the present invention will become apparent to those skilled in the art with the benefit of the following detailed description of the preferred embodiments and upon reference to the accompanying drawings in which:

FIGS. 1 and 2 are schematic diagrams illustrating side views of embodiments of a system configured as described herein;

FIG. 3 is a flow chart illustrating an embodiment of steps performed by a computer subsystem described herein for setting up care areas for inspection of a specimen;

FIGS. 4 and 5 are schematic diagrams illustrating plan views of an example of specimen structures in a design and embodiments of the specimen structures in images generated by an imaging subsystem, an acquired image, segmentation results, a binary image, and a care area generated by the embodiments described herein;

FIG. 6 is a schematic diagram illustrating plan views of examples of specimen structures in images acquired according to embodiments described herein and examples of plots generated for different embodiments of the segmentation described herein; and

FIG. 7 is a block diagram illustrating one embodiment of a non-transitory computer-readable medium storing program instructions for causing a computer system to perform a computer-implemented method described herein.

While the invention is susceptible to various modifications and alternative forms, specific embodiments thereof are shown by way of example in the drawings and are herein described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

The term “defects of interest (DOIs)” as used herein is defined as defects that are detected on a specimen and are really actual defects on the specimen. Therefore, the DOIs are of interest to a user because users generally care about how many and what kind of actual defects are on specimens being inspected. In some contexts, the term “DOI” is used to refer to a subset of all of the actual defects on the specimen, which includes only the actual defects that a user cares about. For example, there may be multiple types of DOIs on any given specimen, and one or more of them may be of greater interest to a user than one or more other types. In the context of the embodiments described herein, however, the term “DOIs” is used to refer to any and all real defects on a specimen.

“Nuisances” (which is sometimes used interchangeably with “nuisance defects”) as that term is used herein is generally defined as defects that a user does not care about and/or events that are detected on a specimen but are not really actual defects on the specimen. Nuisances that are not actually defects may be detected as events due to non-defect noise sources on a specimen (e.g., grain in metal lines on the specimen, signals from underlaying layers or materials on the specimen, line edge roughness (LER), relatively small critical dimension (CD) variation in patterned attributes, thickness variations, etc.) and/or due to marginalities in the inspection system itself or its configuration used for inspection.

The terms “design,” “design data,” and “design information” as used interchangeably herein generally refer to the physical design (layout) of an IC or other semiconductor device and data derived from the physical design through complex simulation or simple geometric and Boolean operations. The design may include any other design data or design data proxies described in commonly owned U.S. Pat. No. 7,570,796 issued on Aug. 4, 2009 to Zafar et al. and U.S. Pat. No. 7,676,077 issued on Mar. 9, 2010 to Kulkarni et al., both of which are incorporated by reference as if fully set forth herein. In addition, the design data can be standard cell library data, integrated layout data, design data for one or more layers, derivatives of the design data, and full or partial chip design data. Furthermore, the “design,” “design data,” and “design information” described herein refers to information and data that is generated by semiconductor device designers in a design process and is therefore available for use well in advance of printing of the design on any physical specimens such as reticles and wafers.

Turning now to the drawings, it is noted that the figures are not drawn to scale. In particular, the scale of some of the elements of the figures is greatly exaggerated to emphasize characteristics of the elements. It is also noted that the figures are not drawn to the same scale. Elements shown in more than one figure that may be similarly configured have been indicated using the same reference numerals. Unless otherwise noted herein, any of the elements described and shown may include any suitable commercially available elements.

One embodiment relates to a system configured for setting up care areas (CAs) for inspection of a specimen. Certain embodiments described herein are configured for segmentation-based CA setup for patterned wafer inspection using an edge detection algorithm or method. For example, the embodiments described herein provide CA setup guided by specimen structures (e.g., die features) and their intensity differentials in specimen images.

The embodiments described herein have a number of advantages such as providing improved inspection sensitivity by creating intensity-based CAs for specimen structure-based features. The embodiments also provide a way to segment specimen structure-based features (mostly brighter than background and commonly a source of noise in light scattering-based tools) by flagging corresponding pixels based on their differential scatter intensity (i.e., the difference in intensity between pixels in an image). In addition, the embodiments advantageously use edge detection to flag corresponding polygons and record their coordinates. The recorded coordinates can be used for creating CAs. The embodiments are independent of inspection platform and can be applied on any patterned wafer irrespective of process layer, type, or technology.

In one embodiment, the specimen is a wafer. The wafer may include any wafer known in the semiconductor arts. Although some embodiments may be described herein with respect to a wafer or wafers, the embodiments are not limited in the specimen for which they can be used. For example, the embodiments described herein may be used for specimens such as reticles, flat panels, personal computer (PC) boards, and other semiconductor specimens.

The term “specimen structures” is used interchangeably herein with the terms “die features,” “patterned features,” and “specimen features.” In general, the term “specimen structures” is defined herein as features in a design for the specimen that are formed on the specimen in a fabrication process. The term “specimen structures” is also used herein to refer to the design features that are patterned on the specimen as opposed to unpatterned layers included in some designs. The “specimen structures” described herein are therefore commonly formed on specimens such as those described herein in processes like lithography and/or etch. In addition, while some defects or foreign material (like particles, fall-on materials, and residual materials) may be considered structures on a specimen in some instances, these are not considered specimen structures in the embodiments described herein. Instead, the term “specimen structures” as used herein refers to only the structures intentionally formed on the specimen in one or more steps of a fabrication process.

One embodiment of such a system includes an imaging subsystem configured for generating images of a specimen. In general, the imaging subsystem includes at least an energy source and a detector. The energy source is configured to generate energy that is directed to a specimen. The detector is configured to detect energy from the specimen and to generate output responsive to the detected energy.

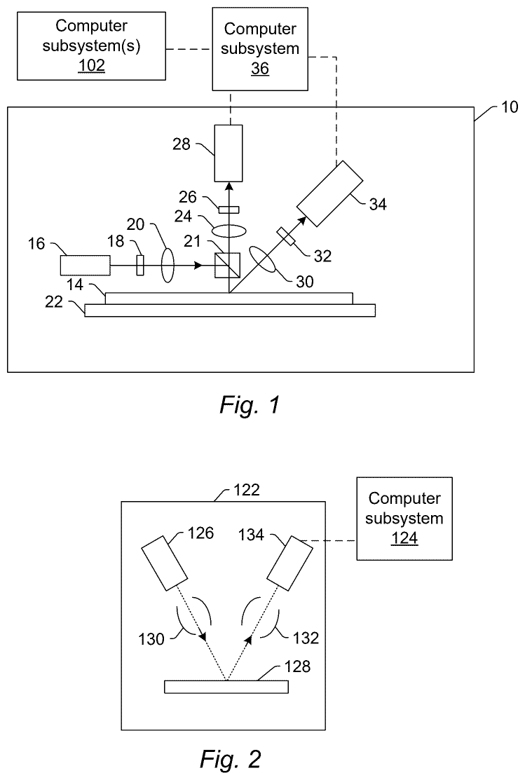

In one embodiment, the imaging subsystem is a light-based imaging subsystem. For example, in the embodiment of the system shown in FIG. 1, imaging subsystem 10 includes an illumination subsystem configured to direct light to specimen 14. The illumination subsystem includes at least one light source, e.g., light source 16. The illumination subsystem is configured to direct the light to the specimen at one or more angles of incidence, which may include one or more oblique angles and/or one or more normal angles. As shown in FIG. 1, light from light source 16 is directed through optical element 18 and then lens 20 to beam splitter 21, which directs the light to specimen 14 at a normal angle of incidence. The angle of incidence may include any suitable angle of incidence, which may vary depending on, for instance, characteristics of the specimen and the defects to be detected on the specimen.

The illumination subsystem may be configured to direct the light to the specimen at different angles of incidence at different times. For example, the imaging subsystem may be configured to alter one or more characteristics of one or more elements of the illumination subsystem such that the light can be directed to the specimen at an angle of incidence that is different than that shown in FIG. 1. In one such example, the imaging subsystem may be configured to move light source 16, optical element 18, and lens 20 such that the light is directed to the specimen at a different angle of incidence.

In some instances, the imaging subsystem may be configured to direct light to the specimen at more than one angle of incidence at the same time. For example, the imaging subsystem may include more than one illumination channel, one of the illumination channels may include light source 16, optical element 18, and lens 20 as shown in FIG. 1 and another of the illumination channels (not shown) may include similar elements, which may be configured differently or the same, or may include at least a light source and possibly one or more other components such as those described further herein. If such light is directed to the specimen at the same time as the other light, one or more characteristics (e.g., wavelength, polarization, etc.) of the light directed to the specimen at different angles of incidence may be different such that light resulting from illumination of the specimen at the different angles of incidence can be discriminated from each other at the detector(s).

In another instance, the illumination subsystem may include only one light source (e.g., source 16 shown in FIG. 1) and light from the light source may be separated into different optical paths (e.g., based on wavelength, polarization, etc.) by one or more optical elements (not shown) of the illumination subsystem. Light in each of the different optical paths may then be directed to the specimen. Multiple illumination channels may be configured to direct light to the specimen at the same time or at different times (e.g., when different illumination channels are used to sequentially illuminate the specimen). In another instance, the same illumination channel may be configured to direct light to the specimen with different characteristics at different times. For example, in some instances, optical element 18 may be configured as a spectral filter and the properties of the spectral filter can be changed in a variety of different ways (e.g., by swapping out the spectral filter) such that different wavelengths of light can be directed to the specimen at different times. The illumination subsystem may have any other suitable configuration known in the art for directing light having different or the same characteristics to the specimen at different or the same angles of incidence sequentially or simultaneously.

In one embodiment, light source 16 includes a broadband plasma (BBP) light source. In this manner, the light generated by the light source and directed to the specimen may include broadband light. However, the light source may include any other suitable light source such as a laser, which may be any suitable laser known in the art configured to generate light at any suitable wavelength(s) known in the art. The laser may be configured to generate light that is monochromatic or nearly-monochromatic. In this manner, the laser may be a narrowband laser. The light source may also include a polychromatic light source that generates light at multiple discrete wavelengths or wavebands.

Light from optical element 18 may be focused to beam splitter 21 by lens 20. Although lens 20 is shown in FIG. 1 as a single refractive optical element, in practice, lens 20 may include a number of refractive and/or reflective optical elements that in combination focus the light from the optical element to the specimen. The illumination subsystem shown in FIG. 1 and described herein may include any other suitable optical elements (not shown). Examples of such optical elements include, but are not limited to, polarizing component(s), spectral filter(s), spatial filter(s), reflective optical element(s), apodizer(s), beam splitter(s), aperture(s), and the like, which may include any such suitable optical elements known in the art. In addition, the system may be configured to alter one or more elements of the illumination subsystem based on the type of illumination to be used for imaging.

The imaging subsystem may also include a scanning subsystem configured to cause the light to be scanned over the specimen. For example, the imaging subsystem may include stage 22 on which specimen 14 is disposed during imaging. The scanning subsystem may include any suitable mechanical and/or robotic assembly (that includes stage 22) that can be configured to move the specimen such that the light can be scanned over the specimen. In addition, or alternatively, the imaging subsystem may be configured such that one or more optical elements of the imaging subsystem perform some scanning of the light over the specimen. The light may be scanned over the specimen in any suitable fashion.

The imaging subsystem further includes one or more detection channels. At least one of the one or more detection channels includes a detector configured to detect light from the specimen due to illumination of the specimen by the imaging subsystem and to generate output responsive to the detected light. For example, the imaging subsystem shown in FIG. 1 includes two detection channels, one formed by collector 24, element 26, and detector 28 and another formed by collector 30, element 32, and detector 34. As shown in FIG. 1, the two detection channels are configured to collect and detect light at different angles of collection. In some instances, one detection channel is configured to detect specularly reflected light, and the other detection channel is configured to detect light that is not specularly reflected (e.g., scattered, diffracted, etc.) from the specimen. However, two or more of the detection channels may be configured to detect the same type of light from the specimen (e.g., specularly reflected light). Although FIG. 1 shows an embodiment of the imaging subsystem that includes two detection channels, the imaging subsystem may include a different number of detection channels (e.g., only one detection channel or two or more detection channels). Although each of the collectors are shown in FIG. 1 as single refractive optical elements, each of the collectors may include one or more refractive optical element(s) and/or one or more reflective optical element(s).

The one or more detection channels may include any suitable detectors known in the art such as photo-multiplier tubes (PMTs), charge coupled devices (CCDs), and time delay integration (TDI) cameras. The detectors may also include non-imaging detectors or imaging detectors. If the detectors are non-imaging detectors, each of the detectors may be configured to detect certain characteristics of the scattered light such as intensity but may not be configured to detect such characteristics as a function of position within the imaging plane. As such, the output that is generated by each of the detectors included in each of the detection channels may be signals or data, but not image signals or image data. In such instances, a computer subsystem such as computer subsystem 36 may be configured to generate images of the specimen from the non-imaging output of the detectors. However, in other instances, the detectors may be configured as imaging detectors that are configured to generate imaging signals or image data. Therefore, the imaging subsystem may be configured to generate images in a number of ways.

Computer subsystem 36 of the system may be coupled to the detectors of the imaging subsystem in any suitable manner (e.g., via one or more transmission media, which may include “wired” and/or “wireless” transmission media) such that the computer subsystem can receive the output generated by the detectors during scanning of the specimen. Computer subsystem 36 may be configured to perform a number of functions using the output of the detectors as described herein and any other functions described further herein. This computer subsystem may be further configured as described herein.

This computer subsystem (as well as other computer subsystems described herein) may also be referred to herein as computer system(s). Each of the computer subsystem(s) or system(s) described herein may take various forms, including a personal computer system, image computer, mainframe computer system, workstation, network appliance, Internet appliance, or other device. In general, the term “computer system” may be broadly defined to encompass any device having one or more processors, which executes instructions from a memory medium. The computer subsystem(s) or system(s) may also include any suitable processor known in the art such as a parallel processor. In addition, the computer subsystem(s) or system(s) may include a computer platform with high speed processing and software, either as a standalone or a networked tool.

If the system includes more than one computer subsystem, the different computer subsystems may be coupled to each other such that images, data, information, instructions, etc. can be sent between the computer subsystems as described further herein. For example, computer subsystem 36 may be coupled to computer subsystem(s) 102 (as shown by the dashed line in FIG. 1) by any suitable transmission media, which may include any suitable wired and/or wireless transmission media known in the art. Two or more of such computer subsystems may also be effectively coupled by a shared computer-readable storage medium (not shown).

Although the imaging subsystem is described above as an optical or light-based subsystem, the imaging subsystem may be an electron-based subsystem. For example, in one embodiment, the energy directed to the specimen includes electrons, and the energy detected from the specimen includes electrons. In this manner, the energy source may be an electron beam source. In one such embodiment shown in FIG. 2, the imaging subsystem includes electron column 122, which is coupled to computer subsystem 124.

As also shown in FIG. 2, the electron column includes electron beam source 126 configured to generate electrons that are focused to specimen 128 by one or more elements 130. The electron beam source may include, for example, a cathode source or emitter tip, and one or more elements 130 may include, for example, a gun lens, an anode, a beam limiting aperture, a gate valve, a beam current selection aperture, an objective lens, and a scanning subsystem, all of which may include any such suitable elements known in the art.

Electrons returned from the specimen (e.g., secondary electrons) may be focused by one or more elements 132 to detector 134. One or more elements 132 may include, for example, a scanning subsystem, which may be the same scanning subsystem included in element(s) 130.

The electron column may include any other suitable elements known in the art. In addition, the electron column may be further configured as described in U.S. Pat. No. 8,664,594 issued Apr. 4, 2014 to Jiang et al., U.S. Pat. No. 8,692,204 issued Apr. 8, 2014 to Kojima et al., U.S. Pat. No. 8,698,093 issued Apr. 15, 2014 to Gubbens et al., and U.S. Pat. No. 8,716,662 issued May 6, 2014 to MacDonald et al., which are incorporated by reference as if fully set forth herein.

Although the electron column is shown in FIG. 2 as being configured such that the electrons are directed to the specimen at an oblique angle of incidence and are scattered from the specimen at another oblique angle, the electron beam may be directed to and scattered from the specimen at any suitable angles. In addition, the electron beam subsystem may be configured to use multiple modes to generate images of the specimen (e.g., with different illumination angles, collection angles, etc.), which may be different in any image generation parameter(s) of the subsystem.

Computer subsystem 124 may be coupled to detector 134 as described above. The detector may detect electrons returned from the surface of the specimen thereby forming electron beam images of the specimen. The electron beam images may include any suitable electron beam images. Computer subsystem 124 may be configured to perform any of the functions described herein using the output of the detector and/or the electron beam images. Computer subsystem 124 may be configured to perform any additional step(s) described herein. A system that includes the imaging subsystem shown in FIG. 2 may be further configured as described herein.

FIGS. 1 and 2 are provided herein to generally illustrate configurations of an imaging subsystem that may be included in the system embodiments described herein. Obviously, the imaging subsystem configuration described herein may be altered to optimize the performance of the system as is normally performed when designing a commercial imaging system. In addition, the systems described herein may be implemented using an existing imaging system (e.g., by adding functionality described herein to an existing inspection system) such as the 29xx and 39xx series of tools that are commercially available from KLA Corp., Milpitas, Calif. For some such systems, the embodiments described herein may be provided as optional functionality of the imaging system (e.g., in addition to other functionality of the imaging system). Alternatively, the imaging subsystem described herein may be designed “from scratch” to provide a completely new imaging system.

Although the imaging subsystem is described above as being a light- or electron beam-based subsystem, the imaging subsystem may be an ion beam-based subsystem. Such an imaging subsystem may be configured as shown in FIG. 2 except that the electron beam source may be replaced with any suitable ion beam source known in the art. Therefore, the energy directed to the specimen may include ions. In addition, the imaging subsystem may be any other suitable ion beam-based imaging subsystem such as those included in commercially available focused ion beam (FIB) systems, helium ion microscopy (HIM) systems, and secondary ion mass spectroscopy (SIMS) systems.

The imaging subsystems described herein may be configured to generate output, e.g., images, of the specimen with multiple modes. In general, a “mode” is defined by the values of parameters of the imaging subsystem used for generating output and/or images of a specimen (or the output used to generate images of the specimen). Therefore, modes may be different in the values for at least one of the parameters of the imaging subsystem (other than position on the specimen at which the output is generated). For example, in an optical subsystem, different modes may use different wavelength(s) of light for illumination. The modes may be different in the illumination wavelength(s) as described further herein (e.g., by using different light sources, different spectral filters, etc. for different modes). In another example, different modes may use different illumination channels of the optical subsystem. For example, as noted above, the optical subsystem may include more than one illumination channel. As such, different illumination channels may be used for different modes. The modes may also or alternatively be different in one or more collection/detection parameters of the optical subsystem. The modes may be different in any one or more alterable parameters (e.g., illumination polarization(s), angle(s), wavelength(s), etc., detection polarization(s), angle(s), wavelength(s), etc.) of the imaging subsystem. The imaging subsystem may be configured to scan the specimen with the different modes in the same scan or different scans, e.g., depending on the capability of using multiple modes to scan the specimen at the same time.

In a similar manner, the electron beam subsystem may generate images with two or more different values of a parameter of the electron beam subsystem. The multiple modes of the electron beam subsystem can be defined by the values of parameters of the electron beam subsystem used for generating images for a specimen. Therefore, modes may be different in the values for at least one of the electron beam parameters of the electron beam subsystem. For example, different modes may use different angles of incidence for illumination.

As noted above, the imaging subsystem may be configured for scanning energy (e.g., light, electrons, etc.) over a physical version of the specimen thereby generating images for the physical version of the specimen. In this manner, the imaging subsystem may be configured as an “actual” subsystem, rather than a “virtual” subsystem. However, a storage medium (not shown) and computer subsystem(s) 102 shown in FIG. 1 may be configured as a “virtual” system. In particular, the storage medium and the computer subsystem(s) may be configured as a “virtual” inspection system as described in commonly assigned U.S. Pat. No. 8,126,255 issued on Feb. 28, 2012 to Bhaskar et al. and U.S. Pat. No. 9,222,895 issued on Dec. 29, 2015 to Duffy et al., both of which are incorporated by reference as if fully set forth herein. The embodiments described herein may be further configured as described in these patents.

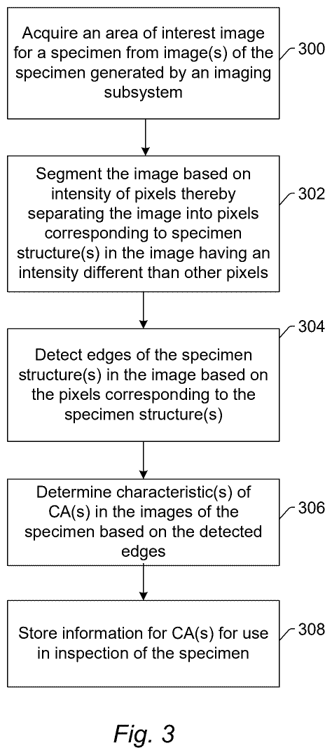

The computer subsystem is configured for acquiring an area of interest image for the specimen from one or more of the images generated by the imaging subsystem, as shown in step 300 of FIG. 3. The specimen may be a patterned wafer provided by a customer or user for inspection. The user may select the optics to be used on the inspection platform for generating the images of the specimen. Acquiring an area of interest image may include simply generating an image of the specimen using an imaging subsystem described herein. Acquiring the area of interest image may, however, be performed without the imaging subsystem. For example, the area of interest image may be acquired from a storage medium (such as one of those described further herein) in which the area of interest image has been stored by another system or method.

In any of such cases, the area of interest image may include simply an image of the specimen generated by a detector of the imaging subsystem. However, as described further herein, acquiring the area of interest image may include generating the area of interest image from two or more images generated by detector(s) of the imaging subsystem. The detector images used to acquire the area of interest image may be generated as described further herein.

The area of interest may be selected to be a region of interest (one or more) or an entire die where systematic noise features are observed. For example, a user or the computer subsystem may select a specimen area of interest such as a die, field, cell, region (e.g., a logic region in a logic device design or a memory region in a memory device design), an area in which certain features of interest are formed, or even an area expected to contain only a single feature or just a few features (2-10 features). The area of interest may also include multiple of any of such areas. In this manner, the area of interest may vary depending on the area for which CAs are being setup (e.g., for an entire die, only in a certain region or part of the die that has unique features, etc.). The user or the computer subsystem may also select one or more parameters (e.g., channels) of the imaging subsystem and one or more dies from the available sample plan of the specimen to be used to grab the images. Although some embodiments may be described herein with respect to a die area of interest, the embodiments are applicable to any other areas of interest described herein.

More generally, though, the term “area of interest” refers to the area of the images used in the embodiments described herein. The area of interest may correspond to an area in the design for the specimen such as those described above. The area of interest may also or alternatively be determined based on inspection recipe parameters. For example, the area of interest may be a frame image generated by the imaging subsystem, a job of frame images that will be collectively processed during defect detection, a swath or sub-swath of images generated during scanning of the specimen, and the like. The size of such images may therefore vary depending on the configuration of the imaging subsystem used for inspection and possibly the image processing parameters used with the images.

The term “area of interest image” as used herein refers, therefore, to simply the image of an area of a specimen that is used for CA setup in the steps described herein. Obviously, then, the CA setup steps described herein may be separately and independently performed for multiple areas of interest on the specimen, and any CAs setup for different areas of interest may be combined into a single set of CAs for runtime inspection of the specimen.

In one embodiment, acquiring the area of interest image includes superimposing two or more of the images of the specimen generated by the imaging subsystem and corresponding to an area of interest on the specimen. This step may be performed to reduce (or even minimize) non-defect related variations in the images that may otherwise skew the CAs. For example, the segmentation described herein may be performed on a die basis. In such instances, two or more die images can be merged for the purpose of reducing, and even minimizing or eliminating, die-to-die variation (like color variation that can affect the segmentation described herein). In one such example, scattered light images may be collected from two or more dies on the specimen and superimposed to reject die-to-die variations. The images that are superimposed may, however, be generated for any other area of interest described herein. More generally, the images that are superimposed should be generated for different instances of the same portion of the design formed on the specimen.

Superimposing the images may be performed by aligning the two or more images to each other using any suitable alignment method or algorithm known in the art. Once the images have been aligned to each other, they can combined in any suitable manner so that similarities between the images are amplified (or at least retained) while differences are reduced. For example, the superimposed image may be generated by averaging the signals at corresponding pixels in each of the images being superimposed so that signals that are common to the images are retained while signals that are different are suppressed. Unlike images that may be merged as described further herein to generate a true picture of the specimen structures on the specimen, the images that are superimposed may be generated with the same imaging subsystem parameters (i.e., the same mode).

The superimposing step may generate an image that is subsequently merged with another image generated with different imaging subsystem parameters to generate the true picture of the specimen structures. Any of the images that are merged with each other as described further herein may be such superimposed images. In other words, images generated with the same imaging parameters and corresponding to the same area in the design for the specimen may be superimposed and then merged with another superimposed image generated from other images also corresponding to the same area in the design but generated with different imaging parameters.

The image superimposition step may also reduce any defect signals in any of the individual images that are superimposed, but that is not the primary reason for performing this step. In general, the images that are used for the steps described herein may be relatively clean, i.e., relatively defect free. If that is not the case or if the defectivity of the images is unknown, the embodiments may be configured for preventing defects on the specimen from being designated as CAs by performing a step after the edge detecting step described further herein in which any polygons found by detecting the edges are compared to one or more size thresholds. The size threshold(s) may be set by the user or the computer subsystem based on any general knowledge about the specimen design like typical critical dimensions of the technology node of the devices being formed on the specimen. The size thresholds may be set so that one is smaller than the smallest of the patterned structures on the specimen layer to be inspected and another is larger than the largest of the patterned structures. In this way, any defects that are smaller or larger than the patterned structures formed on the specimen may not be erroneously detected by the embodiments described herein as specimen structures and erroneously designated as CAs.

In another embodiment, acquiring the area of interest image includes merging two or more of the images of the specimen generated with different parameters of the imaging subsystem and corresponding to an area of interest on the specimen. For example, images generated with different inspection subsystem parameters can be merged to create a near-true image of the die and ensure that all parts of all features are found during CA setup. In this manner, the embodiments may acquire a true image of die (features) for an inspection platform.

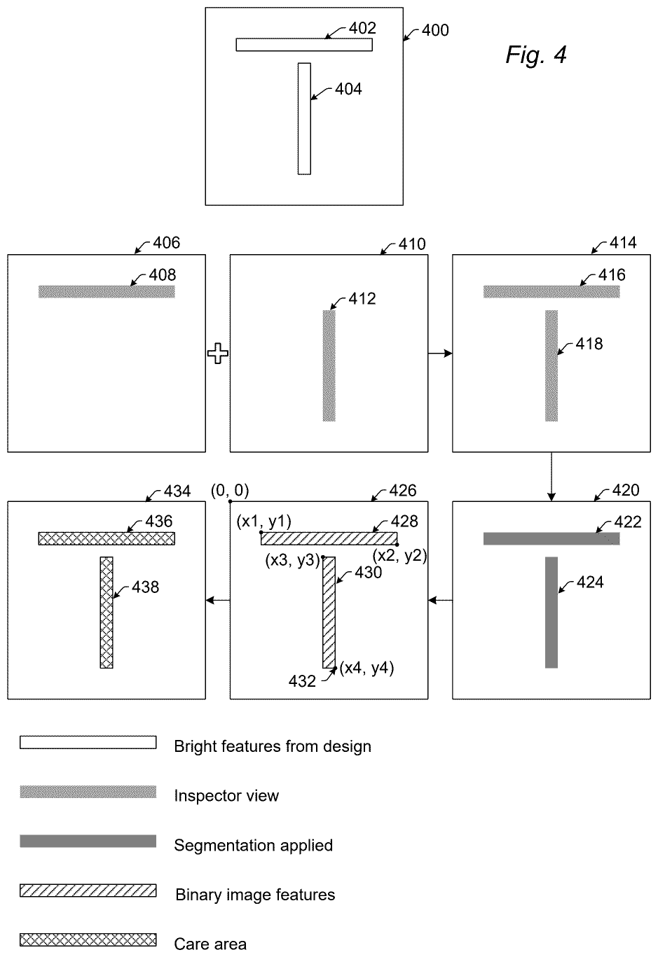

In one such example, FIG. 4 shows a simplified schematic of die 400 in which two specimen structures 402 and 404 are shown. Die 400 is shown in FIG. 4 as it may be represented in a design for the specimen. Therefore, die 400 as shown in FIG. 4 may be a design image for the specimen. Depending on how accurately the design is fabricated on the specimen, die 400 may also represent how the specimen structures are formed on the specimen. Obviously, the specimen structures shown in FIG. 4 are not representative of any specimen structures that may actually be formed on the specimens described herein. Instead, the specimen structures shown in FIG. 4 are only intended to promote understanding of the embodiments described herein.

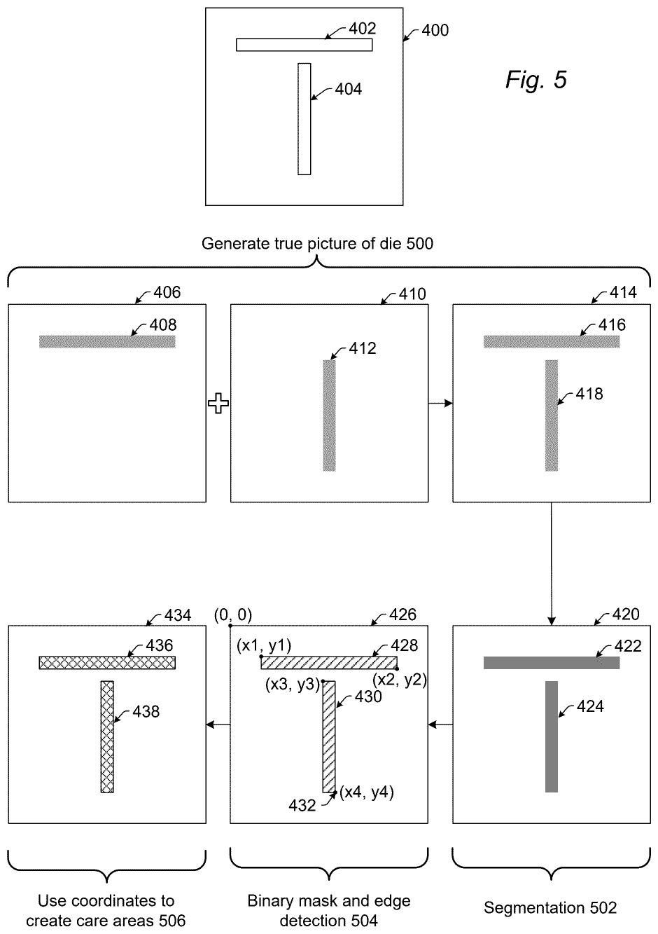

Images of the die separately generated with different parameters of the imaging subsystem may have some substantial differences. For example, image 406 generated with a first set of imaging subsystem parameters only contains image 408 of specimen structure 402. In addition, image 410 generated with a second set of imaging subsystem parameters, different than the first set of imaging subsystem parameters, only contains image 412 of specimen structure 404. In this manner, if only one of these images is used for CA setup, then either specimen structure 402 or specimen structure 404 would not be considered in the CA setup process. However, merging images 406 and 410 produces merged image 414 that includes image 416 of specimen structure 402 and image 418 of specimen structure 404. Therefore, merging the images generated with different imaging subsystem parameters can provide a more accurate representation of the specimen structures formed on the specimen. For example, as shown in FIG. 5, merging images 406 and 410 into merged image 414 may be performed in generate a true picture of die step 500.

Generally, the merging preferably includes an alignment step so that the images that are being merged are accurately aligned to one another. The alignment may include any suitable alignment known in the art. Once the images are aligned, merging may simply include summing the images via some additive function so that the intensity of the different images are added at each aligned pixel. Merging may include more sophisticated steps as well. For example, the merging may be performed with the raw images generated by the detector(s) of the imaging subsystem. Alternatively, some image processing may be performed on the images prior to the actual merging step. The image processing may include, for example, the imaging superimposition described above, low pass filtering to try to minimize background noise in the images, high pass filtering to try to minimize any defects or foreign material that may scatter more strongly than the specimen features, and any other image processing that may be performed during an inspection process. The image processing may also include a kind of defect detection (based on size and/or shape of features in the images rather than actual differences between a test and one or more reference images) to try to minimize the chance that any defects may be erroneously detected as specimen structures. For example, the computer subsystem may determine if any irregularly shaped features are shown in the images (as might be the case if foreign material is on the specimen) and eliminate the signals corresponding to any such features prior to the merging.

In one such embodiment, the different parameters include different collection channels of the imaging subsystem. In one such example, the channels may include a side channel and a top channel, which may be configured as described with respect to the imaging subsystem shown FIG. 1. The collection channels of interest (one or more) may be selected to acquire a true image of the die features, e.g., based on knowledge of the available imaging subsystem parameters. For example, it may be known that one imaging subsystem channel is particularly suitable for imaging horizontally oriented specimen structures and another channel is particularly suitable for imaging vertically oriented specimen structures. Therefore, these channels may be selected for generating the images that are merged to increase the probability that both horizontally and vertically oriented specimen structures are included in the merged image. In this manner, scattered light images generated with the channels of interest may be superimposed to obtain a true image of die features.

In another embodiment, the different parameters are selected to generate the two or more of the images of the specimen with different aspects. For example, multiple collection channels may be used to get views of the specimen structures from different aspects. However, the different aspects may be provided in ways other than (or in addition to) different collection channels. For example, different aspects of the specimen and the specimen structures formed thereon may be provided by different illumination angles (polar and/or azimuthal) and/or different polarizations in either or both of the illumination and collection. Appropriate parameters that are used to provide different aspects of the specimen structures may be selected, for example, based on any information available for the type of device being formed on the specimen and the hardware configurations available on the imaging subsystem.

In a further embodiment, the different parameters include first and second parameters, the two or more of the images generated with the different parameters include a first image generated with the first parameters and a second image generated with the second parameters, and the first image is more responsive to a first portion of the one or more specimen structures than a second portion of the one or more specimen structures and the second image is responsive to the second portion of the one or more specimen structures. Therefore, the different parameters may be more responsive to some specimen structures and less responsive to other specimen structures. Images that qualify as “responsive” to a specimen structure as that term is used herein are images that show a specimen structure with an intensity that is different enough from the background image intensity that it can be found by the steps described herein (e.g., the segmentation and edge detection steps). An image that is responsive to a specimen structure may therefore show that structure relatively faintly as long as it is different enough (brighter or darker) than the background for the purposes described herein.

If one imaging subsystem mode is not known a priori to be responsive to all of the possible specimen structures on a specimen layer for which CAs are being setup, more than one mode may be used to generate the images, and the modes used for imaging may be selected based on their known capability for imaging certain types of specimen structures. In this case, if one of the images is more responsive to first specimen structures than second specimen structures, another of the images is preferably responsive to at least the second specimen structures (regardless of whether that image is also responsive to the first specimen structures).

In the example shown in FIG. 4, the parameters used to generate specimen image 406 are more responsive to specimen structure 402 than specimen structure 404 because image 406 only includes image 408 of specimen structure 402. In contrast, the parameters used to generate specimen image 410 are more responsive to specimen structure 404 than specimen structure 402 because image 410 only includes image 412 of specimen structure 404. Although these images are shown to be responsive to only one specimen structure and not at all responsive to another specimen structure, the images may also be somewhat, if not sufficiently, responsive to all specimen structures (e.g., when a specimen structure image is shown in the image but is difficult to distinguish from noise in the image, rather than simply missing completely as shown in images 406 and 410).

In an additional embodiment, merging the images produces a merged image more similar to a design for the one or more specimen structures than either of the two or more of the images. For example, as shown in FIG. 4, merged image 414 is more similar to die 400 than either of images 406 and 410. The increased similarly between merged image 414 and die 400 is due to the additive nature of the merging step, which is performed as shown in step 500 of FIG. 5 to generate a true picture of the die.

In some embodiments, the different parameters are independent of parameters of the imaging subsystem used for the inspection of the specimen. For example, it is possible to use different collection channels for runtime inspection and for CA setup image grab. In one such example, an inspection platform may include a microscope that is used for grabbing die feature images for CA setup and other collection channels may be used during runtime for inspection. In addition, the images used for CA setup may be generated with more modes than the images used for runtime inspection. For example, as described further herein, different modes may be more or less responsive to certain specimen structures. When it is unclear as to what type of specimen structures are formed on the specimen (as will mostly likely be the case in the embodiments described herein since the design is not relied on for specimen information), it may be advantageous to try a number of different modes to generate the images used for CA setup. The different modes may include more than is practical for use in inspection and may be not needed for inspection. However, more (and even many more) modes may be used for image generation during CA setup than during inspection runtime to make sure that all of the specimen structures on the specimen can be found during CA setup. In this manner, the image merging step may include merging more than two images and as many images as modes used during CA setup.

Such images may in some cases be used to select the modes used for runtime inspection. For example, if the imaging subsystem parameters suitable for inspection of the specimen have not already been established, the images generated for CA setup in the embodiments described herein may also be used to setup the hardware parameters for runtime inspection. In a similar manner, the images may be used for setting up any image processing and/or defect detection parameters for runtime inspection. However, in any case, the imaging subsystem modes used for CA setup may be independent of the modes used for runtime inspection. In particular, since the modes suitable for CA setup are modes that are sensitive to specimen structures on the specimen and the modes suitable for runtime inspection are modes that are sensitive to defects on the specimen, the modes suitable for CA setup may be different than those suitable for runtime inspection. The modes used for the CA setup described herein may therefore be selected independently of any runtime inspection modes.

The acquired specimen images used for CA setup may be different from those used for inspection setup and/or runtime inspection because they are used for different purposes. For example, the images generated for CA setup should generally be responsive to the specimen structures formed on the specimen in that, in combination, the images show all of the specimen structures formed on the specimen. Images that are suitable for inspection, however, do not necessarily need to include images of the patterned features formed on the specimen. For example, test and reference images for the same area in the design for the specimen may be acquired, and the reference image may be subtracted from the test image to generate a difference image thereby canceling out commonalities in the images so that differences between the images can be identified in the difference image as potential defects. Therefore, test and reference images of a patterned feature do not need to show the patterned feature in order to be suitable for detecting differences between the images that may be responsive to defects near or on the patterned feature. So, inspection images may or may not be responsive to specimen structures as long as they are responsive to defects on the specimen.

In this manner, the CAs may be setup as described herein using images that show the specimen structures on the specimen. Once the CAs are setup they can be used to find the CAs in runtime inspection images regardless of whether or not those images show the specimen structures. For example, based on the location information determined for the CAs as described further herein (e.g., CA location with respect to a reference location such as a die corner), those CAs can be found in inspection images regardless of how the specimen structures appear in the inspection images. Therefore, the images acquired and used for CA setup by the embodiments described herein may be different, and even substantially different, than the images used for inspection.

The computer subsystem is configured for segmenting the area of interest image based on intensity of pixels in the area of interest image thereby separating the area of interest image into pixels corresponding to one or more specimen structures in the area of interest image having an intensity different than other pixels in the area of interest image, as shown in step 302 of FIG. 3. This segmentation step may be performed to flag pixels and related features using intensity-based segmentation. For example, the segmentation step segregates specimen structures based on their differential scattering intensity. In this manner, the embodiments described herein use differential intensity of specimen structures to create CAs for inspection. The user may input a threshold that is used for this step such that pixels/features can be flagged and used for other steps described herein. In the example shown in FIG. 4, intensity-based segmentation may be applied to merged image 414 (in segmentation step 502 shown in FIG. 5) thereby producing segmented image 420 in which pixels 422 corresponding to specimen structure 402 and pixels 424 corresponding to specimen structure 404 are separated from each other and other pixels in the image.

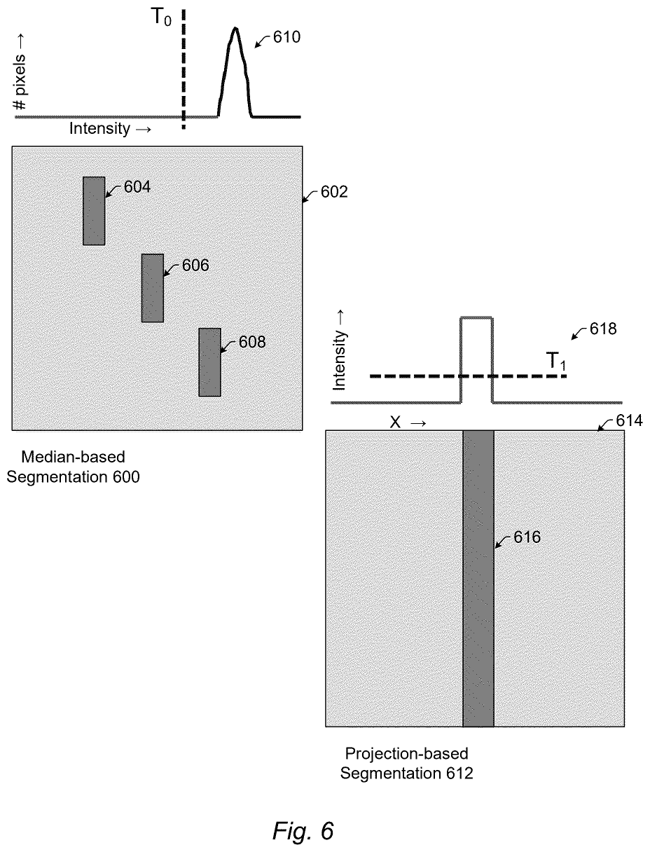

In one embodiment, the segmenting step includes median based segmentation. FIG. 6 illustrates schematically how median based segmentation may be performed. As shown in this figure, median-based segmentation 600 may be performed on acquired area of interest image 602 that includes images of specimen structures 604, 606, and 608. As with other images described herein, the specimen structures shown in FIG. 6 are not meant to show any particular specimen structures that may actually be formed on the specimens described herein, but are intended merely to promote understanding of the embodiments described herein. Median based segmentation may then find the median value of intensity as a function of number of pixels, which is shown schematically in plot 610. A threshold for segmentation, To, shown in this plot may be set as described further herein to separate the pixels based on the median intensity values into those above the threshold and those below the threshold.

In another embodiment, the segmenting step includes projection based segmentation. Projection-based segmentation is also shown schematically in FIG. 6. As shown in FIG. 6, projection-based segmentation 612 may be performed on acquired area of interest image 614 that includes an image of specimen structure 616. Projection-based segmentation may include plotting the value of intensity as a function of position in the X direction in this case, as shown in plot 618. A threshold for segmentation, T₁, shown in this plot may be set as described further herein to separate the pixels into those having intensities above the threshold and those having intensities below the threshold.

In some embodiments, the segmenting step includes applying a segmentation method to the area of interest image, displaying results of the segmentation method to a user, receiving from the user a cutline threshold for the separating, and performing the separating with the cutline threshold. For example, the computer subsystem may apply a segmentation method as described above and then display pixel intensity and intensity-based segmentation results for the specimen (e.g., plot 610 or 618). The user may be able to segment the area of interest image using a thresholding value. In particular, displaying the results to the user as described above can help the user to decide what cutline is appropriate for segmentation. Providing such information to the user may not be necessary but a user may find it relatively difficult to set the cutline threshold without such information. In this way, the embodiments described herein provide user flexibility. Separating the pixels with the cutline threshold may then be performed in any appropriate manner. The computer subsystem may then export the post-segmentation image along with pixel information (x, y locations relative to die origin).

The computer subsystem is configured for detecting edges of the one or more specimen structures in the area of interest image based on the pixels corresponding to the one or more specimen structures, as shown in step 304 of FIG. 3. This step may be performed using the image exported by the segmentation step. The edge detection may be performed to find the x, y coordinates for each polygon, which can then be used to create CAs as described further herein.

In one embodiment, detecting the edges includes applying a binary mask to the segmented area of interest image to generate a binary image of the one or more specimen structures and detecting the edges of the one or more specimen structures in the binary image, as shown in binary mask and edge detection step 504 in FIG. 5. For example, after the relevant pixels and corresponding polygons are flagged using segmentation thresholds, the computer subsystem may apply a binary mask that sets pixels above the threshold to the max value and below are set to a min value. In other words, detecting the edges may include flagging features into polygons and using a binary mask where pixels above a threshold are set to max and below are set to min. Then, the edge detection method or algorithm may be applied to record end points relative to die corner or another suitable reference location.

In the example shown in FIG. 4, a binary mask may be applied to segmented image 420 thereby generating binary image 426 containing binary image feature 428 corresponding to specimen structure 402 and binary image feature 430 corresponding to specimen structure 404. Obviously, the binary image may, in practice, be an actual black and white image or at least an image in which the binary features are shown in solid black. The binary features are not shown in solid black in FIG. 4 only because solid black areas are discouraged in patent drawings. Edge detection may then be performed using binary image 426.

Applying a binary mask as described above is not necessary for the embodiments described herein but may in some instances improve the results generated by the embodiments. For example, the embodiments may advantageously apply the binary mask (set pixels above threshold to max and below to min) to ease the application of an edge detection method or algorithm to flag polygon endpoints (e.g., relative to the die corner) as described further herein. In this manner, the binary masking may help improve the edge detection step that is performed for identifying the specimen structure(s) and determining information for them (such as coordinates) for other steps described herein. However, the edge detection step may be performed with any suitable edge detection method or algorithm known in the art, and some of these methods and systems may benefit from the binary masking step more than others.

The computer subsystem is configured for determining one or more characteristics of one or more CAs in the images of the specimen based on the detected edges, as shown in step 306 of FIG. 3. In one embodiment, determining the one or more characteristics includes identifying end points of the one or more specimen structures in the area of interest image based on the detected edges and determining the one or more characteristics based on the identified end points. For example, as described above, the edge detection method or algorithm may record end points of the specimen structures relative to the die corner, e.g., as shown in binary image 426 shown in FIG. 4. The computer subsystem may then use these end points as the characteristics of the one or more CAs. For example, as shown in step 506 of FIG. 5, the computer subsystem may use the coordinates of the end points in the binary image to create CAs. The computer subsystem may also determine additional or other characteristics of the CA(s) such as die corner relative coordinates, size, shape, etc. that can be determined for the specimen structures in the image from the recorded end points and/or any other information determined with the detected edges. The X-Y coordinates of these polygons and any of the other information described above may then be used to create CAs for inspection. In this manner, the computer subsystem may use the reported end points to generate customized CAs.

In the example shown in FIG. 4, identifying the end points may be performed with binary image 426. The end points in this example may be two opposing corners of the binary features (one of such corners indicated with reference numeral 432 in FIG. 4). The end points may be recorded in (x, y) coordinates and used to create CAs. For example, the end point coordinates that are determined for binary image feature 428 may include (x1, y1) and (x2, y2) shown in FIG. 4 at opposing corners of the image feature. Similarly, the end point coordinates determined for binary image feature 430 may include (x3, y3) and (x4, y4) shown in FIG. 4 at opposing corners of this image feature. These coordinates may also be determined relative to the die corner indicated in FIG. 4 with the (0,0) coordinates, which may be identified in any of the images described herein in any suitable manner. The end points, their coordinates, and any other information determined by the embodiments described herein may then be used to designate different CAs for different specimen structures as shown in image 434, e.g., CA 436 for specimen structure 402 and CA 438 for specimen structure 404.

In one embodiment, the one or more specimen structures are sources of systematic noise in the images of the specimen generated for the inspection of the specimen. For example, die-based features can possibly be sources of systematic noise (meaning that they cause noise in images in a systematic (rather than random) way), and CAs created by the embodiments described herein can help to suppress such noise. In particular, the CAs for such features may be assigned relatively high thresholds (for reduced sensitivity) or as Do Not Care areas (so they are not inspected at all). In this manner, the refined CAs created by the embodiments described herein can help inspection platforms reduce nuisance rate by reducing the amount of systematic noise that is erroneously detected as potential defects. Reducing the nuisance rate increases the likelihood of finding real defects and reduces scanning electron microscope (SEM) defect review loading for inspection tool users.

Although creating CAs for the purpose of reducing systematic noise from specimen structures is one particularly advantageous use of the embodiments described herein, the embodiments may be used for setting up curated CAs for any other purpose for inspection. In this manner, the CAs generated as described herein can be used for optimal inspection in a number of ways. If the specimen structures are a noise source, then a colder (higher) defect detection algorithm threshold may be set for the CAs generated for the specimen structures so they are inspected with a reduced sensitivity. If the specimen structures are regions of interest or are included in regions of interest, then the inspection may be performed with a hotter (lower) defect detection algorithm threshold for the CAs generated for the specimen structures so they are inspected with a higher sensitivity. CAs setup for the specimen structures may also be flagged as do not inspect areas where appropriate. In addition, the embodiments described herein can be applied to all inspection platforms (DF or BF, even though the inventors have demonstrated the functionality using DF as an example) and both advanced technology and legacy node layers alike.

The CAs setup as described herein may also include different types of CAs for a single specimen. For example, obviously specimens such as those described herein often have different types of specimen structures formed on the same layer. Images of the specimen generated in the inspection of one layer may therefore include images of different types of specimen structures. Examples of such different types of specimen structures include, but are not limited to, contact holes, isolated line type structures, dense line/space structures, and larger structures like dummy features and alignment marks. Some of these structures are more important than others, and some may be not of interest at all. Therefore, when different types of specimen structures are included in inspection images, different types of CAs may be appropriate.

Information for the different types of CAs may be acquired from the results of the embodiments described herein. For example, the results of the edge detection step may be used to determine information such as the size, shape, and position of the specimen structures in the design for the specimen. General information about specimen structures having such characteristics may be used to determine appropriate inspection parameters for the specimen structures. For example, dense line/space structures are generally fairly important while alignment marks are not. Therefore, the dense/line space structures may be inspected with a hotter defect detection threshold than the alignment mark structures. In another example, dummy structures may not be of interest at all and may therefore be designated as do not care areas. The computer subsystem may therefore be configured to use such general information to determine or suggest different inspection parameters for the different structures found by the embodiments described herein.

The computer subsystem may also be configured to display information for the found specimen structures to a user and provide means for the user to set a CA type and/or one or more inspection parameters for each (or one or more) of the specimen structures. For example, the computer subsystem may be configured to display binary images such as binary image 426, optionally with any other information determined for the specimen structures, to a user. The computer subsystem may also display suggested CA type(s) and/or one or more suggested inspection parameters to the user, which may then be accepted, rejected, or modified by the user. The computer subsystem may also or alternatively provide a user interface (UI) that can provide different ways for the user to input CA type(s) and/or inspection parameters for the found specimen structures. The computer subsystem may also group any one or more instances of the CAs having the same type or to be inspected with the same inspection parameters into a CA group (CAG), which can in some instances simplify the runtime inspection operation.

In some embodiments, the imaging subsystem is configured for generating the images of the specimen by detecting light scattered from the specimen, and the one or more specimen structures scatter the light more strongly than defects on the specimen. For example, the embodiments described herein are particularly suitable for creating detailed CAs for relatively bright specimen features on a patterned wafer. These CAs can be treated as noise sources or handled per inspection requirement (inspected hotter or colder) or can be flagged as Do Not Inspect areas (i.e., Do Not Care Areas or non-CAs). Since these features usually scatter stronger (and hence are brighter in DF tools) than the background, they can be flagged based on differential scattered light intensity as described further herein.

In a further embodiment, the computer subsystem is configured for performing the acquiring, segmenting, detecting, determining, and storing steps without information for a design for the specimen. In particular, as described further herein, the embodiments work based on intensity differential and do not need access to design files for any reason. In other words, the embodiments described herein may be performed using only images of the specimen generated by the inspection subsystem (possibly with some input from the user as described further herein). Therefore, the embodiments are particularly advantageous for CA setup when one entity owns the design for the specimen and another entity is setting up the inspection process for the specimen, which is a situation commonly encountered today.

The computer subsystem is also configured for storing information for the one or more CAs for use in inspection of the specimen, as shown in step 308 of FIG. 3. For example, the computer subsystem may generate a CA file, which may have any suitable file format or extension such as a .bin file. The information for the one or more CAs may include any suitable information such as CA location and size. During the inspection, the tool that is performing the inspection, which may or may not include the imaging subsystem and computer subsystem described herein, may auto-create CAs with the locations and dimensions specified by the stored information. In some such instances, the inspection tool may import the stored information or a representation of it into a CA UI in a Main UI of the inspection tool so that a user of the tool can gain an understanding of the information.

The computer subsystem may also be configured to store the CA information in a recipe or by generating a recipe for the inspection in which the CAs will be used. A “recipe” as that term is used herein is defined as a set of instructions that can be used by a tool to perform a process on a specimen. In this manner, generating a recipe may include generating information for how a process is to be performed, which can then be used to generate the instructions for performing that process. The information for the CAs that is stored by the computer subsystem may include any information that can be used to identify, access, and/or use the selected CAs (e.g., such as a file name and where it is stored). The information for the CAs that is stored may also include the actual code, instructions, algorithms, etc. for applying the CAs and detecting defects based on the applied CAs.

The computer subsystem may be configured for storing the information for the CAs in any suitable computer-readable storage medium. The information may be stored with any of the results described herein and may be stored in any manner known in the art. The storage medium may include any storage medium described herein or any other suitable storage medium known in the art. After the information has been stored, the information can be accessed in the storage medium and used by any of the method or system embodiments described herein, formatted for display to a user, used by another software module, method, or system, etc. For example, the embodiments described herein may generate an inspection recipe as described above. That inspection recipe may then be stored and used by the system or method (or another system or method) to inspect the specimen or other specimens (of the same layer) to thereby generate information (e.g., defect information) for the specimen or other specimens.

The computer subsystem may be configured for performing defect detection in the inspection process using the CAs setup as described herein. For instance, the imaging subsystems described herein may be configured for generating test images of a specimen during an inspection process. The CAs can be found in the test images using information for the CAs described herein. The computer subsystem may then perform defect detection (and possibly ignore any do not care areas) based on the information for the CAs. For example, the computer subsystem may subtract a reference image from a test image to thereby generate a difference image. Detecting the defects may also include applying some threshold to the difference image, and that threshold may be commonly referred to in the art as a defect detection threshold. The threshold that is used for defect detection performed in any of the CAs may be determined as described herein (e.g., hotter for CAs needing more sensitive inspection and colder for CAs needing less sensitive inspection). Any image signals or data in the difference image having a value above the threshold may be identified by the computer subsystem as a defect or potential defect. All other image signals or data in the difference image may not be identified as a defect or potential defect.

Of course, this is perhaps the most simple version of how defect detection can be performed using results of subtracting a reference image from a test image. The embodiments described herein are not limited in the defect detection method or algorithm that can be used with the test and reference images. For example, once the reference image has been subtracted from the test image, there are many different types of defect detection methods or algorithms that can be used to detect defects or potential defects in the resulting difference image. Any or all such defect detection methods or algorithms can be used in the embodiments described herein, and an appropriate method or algorithm can be selected based on information about the specimen.

Results and information generated by performing the inspection on the specimen or other specimens of the same type may be used in a variety of manners by the embodiments described herein and/or other systems and methods. Such functions include, but are not limited to, altering a process such as a fabrication process or step that was or will be performed on the inspected specimen or another specimen in a feedback or feedforward manner. For example, the computer subsystem described herein may be configured to determine one or more changes to a process that was performed on a specimen inspected as described herein and/or a process that will be performed on the specimen based on the detected defect(s). The changes to the process may include any suitable changes to one or more parameters of the process. The computer subsystem preferably determines those changes such that the defects can be reduced or prevented on other specimens on which the revised process is performed, the defects can be corrected or eliminated on the specimen in another process performed on the specimen, the defects can be compensated for in another process performed on the specimen, etc. The computer subsystem described herein may determine such changes in any suitable manner known in the art.

Those changes can then be sent to a semiconductor fabrication system (not shown) or a storage medium (not shown) accessible to the computer subsystem described herein and the semiconductor fabrication system. The semiconductor fabrication system may or may not be part of the system embodiments described herein. For example, the system described herein may be coupled to the semiconductor fabrication system, e.g., via one or more common elements such as a housing, a power supply, a specimen handling device or mechanism, etc. The semiconductor fabrication system may include any semiconductor fabrication system known in the art such as a lithography tool, an etch tool, a chemical-mechanical polishing (CMP) tool, a deposition tool, and the like.

As described herein, therefore, the embodiments can be used to setup a new inspection process or recipe. The embodiments may also be used to modify an existing inspection process or recipe, whether that is an inspection process or recipe that was used for the specimen or was created for one specimen and is being adapted for another specimen. In addition, the embodiments described herein are not just limited to CA creation or modification. For example, the embodiments described herein can also be used to select one or more other parameters for the inspection such as mode selection performed based on the systematic noise sources identified by the embodiments described herein, output processing parameter selection such as a defect detection sensitivity to be used in the systematic nuisance source areas versus the other areas, and any other parameters of the inspection process for which the CAs were setup as described herein.

The embodiments described herein provide a number of advantages in addition to those already described over previously used methods and systems for setting up CAs for inspection processes. For example, the embodiments described herein can advantageously reduce the time required for recipe creation. In addition, the embodiments described herein can be used to create refined CAs specific to die-based features, which can improve sensitivity of inspection and help catch more key DOIs, which can in turn improve customer yield. The embodiments described herein also provide improved ease of use. For example, a user may only grab die image(s) using inspection optics and adjust segmentation parameters as desired. The x, y coordinates (recorded by the edge detection step) can be used to create the required CAs. Therefore, the embodiments also reduce the need for expertise in design-based CA algorithms and methods.

Each of the embodiments of each of the systems described above may be combined together into one single embodiment.

Another embodiment relates to a computer-implemented method for setting up CAs for inspection of a specimen. The method includes the acquiring an area of interest image, segmenting the area of interest image, detecting edges, determining one or more characteristics of CA(s) in the images, and storing information steps described above.

Each of the steps of the method may be performed as described further herein. The method may also include any other step(s) that can be performed by the imaging subsystem, computer subsystem, and/or system described herein. The steps of the method are performed by a computer subsystem coupled to an imaging subsystem, both of which may be configured according to any of the embodiments described herein. In addition, the method described above may be performed by any of the system embodiments described herein.

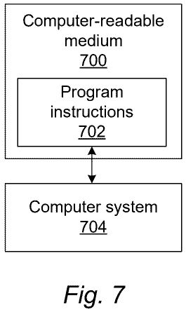

An additional embodiment relates to a non-transitory computer-readable medium storing program instructions executable on a computer system for performing a computer-implemented method for setting up CAs for inspection of a specimen. One such embodiment is shown in FIG. 7. In particular, as shown in FIG. 7, non-transitory computer-readable medium 700 includes program instructions 702 executable on computer system 704. The computer-implemented method may include any step(s) of any method(s) described herein.

Program instructions 702 implementing methods such as those described herein may be stored on computer-readable medium 700. The computer-readable medium may be a storage medium such as a magnetic or optical disk, a magnetic tape, or any other suitable non-transitory computer-readable medium known in the art.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (“MFC”), SSE (Streaming SIMD Extension) or other technologies or methodologies, as desired.

Computer system 704 may be configured according to any of the embodiments described herein.

Further modifications and alternative embodiments of various aspects of the invention will be apparent to those skilled in the art in view of this description. For example, methods and systems for setting up CAs for inspection of a specimen are provided. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A system configured to set up care areas for inspection of a specimen, comprising:
an imaging subsystem configured for generating images of a specimen; and
a computer subsystem configured for:
acquiring an area of interest image for the specimen from one or more of the images generated by the imaging subsystem;
segmenting the area of interest image based on intensity of pixels in the area of interest image thereby separating the area of interest image into pixels corresponding to one or more specimen structures in the area of interest image having an intensity different than other pixels in the area of interest image;
detecting edges of the one or more specimen structures in the area of interest image based on the pixels corresponding to the one or more specimen structures;
determining one or more characteristics of one or more care areas in the images of the specimen based on the detected edges; and
storing information for the one or more care areas for use in inspection of the specimen.

2. The system of claim 1, wherein acquiring the area of interest image comprises superimposing two or more of the images of the specimen generated by the imaging subsystem and corresponding to an area of interest on the specimen.

3. The system of claim 1, wherein acquiring the area of interest image comprises merging two or more of the images of the specimen generated with different parameters of the imaging subsystem and corresponding to an area of interest on the specimen.

4. The system of claim 3, wherein the different parameters comprise different collection channels of the imaging subsystem.

5. The system of claim 3, wherein the different parameters are selected to generate the two or more of the images of the specimen with different aspects.

6. The system of claim 3, wherein the different parameters comprise first and second parameters, wherein the two or more of the images generated with the different parameters comprise a first image generated with the first parameters and a second image generated with the second parameters, and wherein the first image is more responsive to a first portion of the one or more specimen structures than a second portion of the one or more specimen structures and the second image is responsive to the second portion of the one or more specimen structures.

7. The system of claim 3, wherein said merging produces a merged image more similar to a design for the one or more specimen structures than either of the two or more of the images.

8. The system of claim 3, wherein the different parameters are independent of parameters of the imaging subsystem used for the inspection of the specimen.

9. The system of claim 1, wherein said segmenting comprises median based segmentation.

10. The system of claim 1, wherein said segmenting comprises projection based segmentation.

11. The system of claim 1, wherein said segmenting comprises applying a segmentation method to the area of interest image, displaying results of the segmentation method to a user, receiving from the user a cutline threshold for said separating, and performing said separating with the cutline threshold.

12. The system of claim 1, wherein detecting the edges comprises applying a binary mask to the segmented area of interest image to generate a binary image of the one or more specimen structures and detecting the edges of the one or more specimen structures in the binary image.

13. The system of claim 1, wherein the one or more specimen structures are sources of systematic noise in the images of the specimen generated for the inspection of the specimen.

14. The system of claim 1, wherein the imaging subsystem is further configured for generating the images of the specimen by detecting light scattered from the specimen, and wherein the one or more specimen structures scatter the light more strongly than defects on the specimen.

15. The system of claim 1, wherein the computer subsystem is further configured for performing the acquiring, segmenting, detecting, determining, and storing without information for a design for the specimen.

16. The system of claim 1, wherein determining the one or more characteristics comprises identifying end points of the one or more specimen structures in the area of interest image based on the detected edges and determining the one or more characteristics based on the identified end points.

17. The system of claim 1, wherein the imaging subsystem is a light-based imaging subsystem.

18. The system of claim 1, wherein the imaging subsystem is an electron-based imaging subsystem.

19. A non-transitory computer-readable medium, storing program instructions executable on a computer system for performing a computer-implemented method for setting up care areas for inspection of a specimen, wherein the computer-implemented method comprises:
acquiring an area of interest image for a specimen from one or more images of the specimen generated by an imaging subsystem;
segmenting the area of interest image based on intensity of pixels in the area of interest image thereby separating the area of interest image into pixels corresponding to one or more specimen structures in the area of interest image having an intensity different than other pixels in the area of interest image;
detecting edges of the one or more specimen structures in the area of interest image based on the pixels corresponding to the one or more specimen structures;
determining one or more characteristics of one or more care areas in the images of the specimen based on the detected edges; and
storing information for the one or more care areas for use in inspection of the specimen.

20. A computer-implemented method for setting up care areas for inspection of a specimen, comprising:
acquiring an area of interest image for a specimen from one or more images of the specimen generated by an imaging subsystem;
segmenting the area of interest image based on intensity of pixels in the area of interest image thereby separating the area of interest image into pixels corresponding to one or more specimen structures in the area of interest image having an intensity different than other pixels in the area of interest image;
detecting edges of the one or more specimen structures in the area of interest image based on the pixels corresponding to the one or more specimen structures;
determining one or more characteristics of one or more care areas in the images of the specimen based on the detected edges; and
storing information for the one or more care areas for use in inspection of the specimen, wherein the acquiring, segmenting, detecting, determining, and storing steps are performed by a computer subsystem coupled to the imaging subsystem.
